(19) United States
(12) Patent Application Publication
(10) Pub. No.: US 2025/0364879 A1
(43) Pub. Date: Nov. 27, 2025

(54) Drive Apparatus for Moving a Darkening, Moving or Closing Device

(71) Applicant: FEIG Electronic GmbH, Weilburg (DE)

(72) Inventors: Dirk SCHÄFER, Weilmünster (DE); Gabor ANDRÄ, Limburg an der Lahn (DE); Norman KERSTEN, Wiesbaden (DE); Christian GRAF, Herborn (DE); Michael SCHELLENBERG, Bendorf (DE)

(73) Assignee: FEIG Electronic GmbH, Weilburg (DE)

(21) Appl. No.: 19/099,489

(22) PCT Filed: Jul. 24, 2023
(86) PCT No.: PCT/EP2023/070404

§ 371 Date: Jan. 29, 2025

(30) Foreign Application Priority Data
Jul. 29, 2022 (DE) 102022119074.9

(51) Int. Cl. H02K 11/35; E05F 15/603; H02K 5/20; H02K 5/22; H02K 7/102; H02K 7/116

(52) U.S. Cl. CPC H02K 11/35; E05F 15/603; H02K 5/207; H02K 5/225; H02K 7/102; H02K 7/116; E05Y 2201/408; E05Y 2201/71; E05Y 2400/44; E05Y 2400/502; H02K 2205/09

(57) ABSTRACT

A drive apparatus (20) for moving a darkening, moving, or closing device (18), such as a garage door, has a drive motor (2) and a gearbox/transmission (1) which is located in the drive train between the output shaft of the drive motor (2) and the input shaft (21) of the darkening, moving, or closing device (18). A sensor and analysis unit (8) is mechanically fixedly connected to the apparatus (20) for determining a state of wear of the drive apparatus (20) and/or the drive motor (2) and/or the transmission (1) and/or a first brake (3) and/or the darkening, moving, or closing device (18). Characteristic data of the drive apparatus (20) in the form of an electronic type plate (45) are stored in the sensor and analysis unit (8). The sensor and analysis unit (8) is connected to an open-loop and/or closed-loop control device (13) of the drive motor (2) for transmitting and receiving data.

### CROSS-REFERENCE TO RELATED APPLICATIONS

This application is a national stage application (under 35 USC § 371) of PCT/EP2023/070404, filed Jul. 24, 2023, which claims benefit of DE 102022119074.9, filed Jul. 29, 2022, the contents of each of which is incorporated by reference herein.

### BACKGROUND OF THE INVENTION

The invention relates to a drive mechanism for moving a darkening, adjusting, or closure device.

A darkening, adjusting, or closure device is understood to mean, for example, devices that can be used to close off buildings or a site. This includes loads that can be raised and lowered, such as gates, in particular roller shutters, garage doors, industrial doors, shutters, room dividers, smoke protection curtains, or even sliding gates, barriers, trap doors. However, adjustable work platforms are also conceivable. This list is exemplary and not exhaustive.

The standard electric motor-driven drives for gates, the so-called gate drives or drive devices, usually consist of an electric motor, which is usually designed as a low-cost asynchronous three-phase motor, and which in most cases is connected to a directly flanged gearbox, wherein the gearbox is often designed as a so-called worm gearbox.

It is also known, according to the prior art, for example EP 1 882 802 B1, to feed gate drives via a frequency converter so that the gate can be moved at different speeds and to allow the gate to start and stop gently.

As mentioned, familiar drive mechanisms are used, on the one hand, to motorize the darkening, adjusting, or closure device. On the other hand, they usually have additional components, such as a drive motor and a control unit for controlling the drive motor, as well as sensors for transmitting safety-related information to the control unit.

Generally, the control device has the task of controlling the electric drive motor for the movement, for example, the opening and closing movement or the lifting and lowering movement of the darkening, adjusting, or closure device, of processing the signals from the control sensors to move the device, to scan sensors to determine the position of the darkening, adjusting, or closure device and to process this information, and to evaluate the signals from safety sensors and to control the drive motor according to this information.

Such a gate control system is known, for example, from DE 10 2010 000 060 B4.

To minimize the risk of personal injury or property damage from a motor-driven darkening, adjusting, or closure device, the system, consisting of the darkening, adjusting, or closure device, drive motor, control system, and sensors, must meet applicable technical standards that ensure safe operation of the entire drive system. Relevant standards for this are, for example, DIN EN 12453, entitled “Gates—Safe use of power-operated gates—3 Requirements” and DIN EN ISO 13849, entitled “Safety of machinery—Safety-related parts of control systems”, which describe the general requirements for the gate system.

For example, a drive arrangement for raising and lowering loads, such as roller shutters, is known from DE 20 2012 001 954 U1, having at least one drive motor with at least one winding shaft that can be driven by the drive motor for raising and lowering the load, with at least one gearbox for each drive motor for connecting the drive motor to the winding shaft in a drive-like manner. The gearbox has a transmission mechanism, in particular an endlessly circulating drive chain, and at least one safety catch to prevent it from falling.

DE 20 2008 016 304 U1 relates to a device for monitoring a drive unit with a motor and a gearbox, preferably for monitoring a drive unit for driving winding shafts having opening closures rolled up on the winding shaft, and a drive unit comprising a motor and a gearbox, preferably a drive unit for driving winding shafts having opening closures rolled up on the winding shaft.

Electric drives for lifting or transportation tasks are often designed as geared motors due to the high gear ratios required. The gearing components required for this, such as gears, worm gears, or worm shafts, are subject to regular wear due to the high surface pressures at the contact points when power is transmitted from one gearing component to another, despite lubrication. Particularly in the case of lifting tasks, for example, these drives are used to move large masses upwards and hold them there, which inevitably leads to a safety-relevant situation.

The worm gear of the worm gearbox is particularly critical for a possible gate crash. This is because the teeth on the worm gear are design-related, constructive wear parts, since the soft material of the worm gear usually rubs against the hard material of the worm shaft.

The worm gear is therefore already heavily and almost evenly worn due to frequent use. A sudden overload on the gearbox, for example due to an emergency or quick stop, can create a shock that can exhibit high, cyclic vibrations.

Such an impact can cause gradual damage or destruction of the gearing components.

Holding the raised mass is usually achieved by electromechanically actuated brakes on the drive shaft or other holding mechanisms, such as mechanical locks. If the mass is to move down again in a controlled manner, these holding mechanisms must be released.

These holding mechanisms, the power-transmitting gearing components and the welded or bolted connections in the power flow of the drive application, e.g., a hanging or a door system, are of great safety relevance. If these mechanisms fail, the mass lifted by the drive, for example a wound-up door curtain, can crash.

For this reason, devices are required for these mechanisms to ensure that the lifted mass cannot fall due to a defect in these mechanisms (so-called single-fault safety). This can be done by replacing the drive or individual components in good time. It is also conceivable to use a second holding brake in the drive system and/or a mechanical gearbox breakage protection device, in which, however, the drive is only permanently blocked after a tooth breakage of a gearing component of a gearbox, for example a worm gear (so-called “safety gearbox”).

Current systems are based primarily on inherently safe design and/or interval-dependent maintenance, including the replacement of components.

However, the relevant input variables such as load/torque, speed, number of cycles, oil loss, temperature, shock, and vibration load or ageing are not monitored, or only in an organizational sense. This also applies to the impact described above, which can lead to cyclic vibrations that occur during a door movement after the impact that caused the deformation or break but did not cause the door to fall, but which are not detected in the prior art. This repeatedly causes the drive to fail and sometimes leads to dangerous situations, such as uncontrolled movement or even the crash of a door curtain.

A disadvantage of known gate drives is the non-negligible risk of the hanging or gate crashing down, triggered by a failure of the holding brake of a drive mechanism and/or the theoretically possible breaking of teeth on gearbox components, because the state of wear of relevant components is not known or is not known precisely enough. For well-known drives, this also leads to the drive being replaced too early or too late, i.e., a waste of materials or resources or a risk of the goal crashing.

Based on the disadvantages described above, the object of the invention is to determine the (wear) condition of relevant components of a drive mechanism and/or a darkening, adjusting, or closure device with sufficient accuracy, in particular in order to carry out the challenge of replacing or maintaining the drive when a defined wear limit is reached, i.e., not too early and not too late, for reasons of safety, cost, and sustainability.

### SUMMARY OF THE INVENTION

The subject of the invention is a drive mechanism for moving a darkening, adjusting, or closure device, in particular in the form of a hanging, roller shutter, garage door, roller blind, room divider, smoke protection curtain, sliding gate, folding gate, lamella, an adjustable work platform or the like, with a drive motor that can be driven by means of an electrical drive signal to move the darkening, adjusting, or closure device, wherein the drive motor has a motor control connected to a control and/or regulating device for controlling the darkening, adjusting, or closure device or is connected to such a device.

As mentioned, darkening, adjusting, or closure devices can be understood, for example, to mean devices with which buildings or a site can be closed. This includes loads that can be raised and lowered, such as gates, in particular roller shutters, garage doors, industrial doors, shutters, room dividers, smoke protection curtains, or even sliding gates, barriers, trap doors. However, adjustable work platforms are also conceivable.

The drive motor can be designed as an electric motor, in particular as an asynchronous motor.

Furthermore, the drive mechanism according to the invention comprises a gearbox (alternatively can be called a transmission) arranged in the drive train between the output shaft of the drive motor and the drive shaft of the darkening, adjusting, or closure device. It is conceivable that the gearbox is designed as a worm gearbox or as a bevel gearbox.

According to the invention, the device also has a sensor and evaluation unit that is firmly connected to the device for diagnosis and evaluation, in particular for determining the state of wear of the drive device and/or the drive motor and/or the gearbox and/or a first brake and/or the darkening, adjusting, or closure device.

The sensor and evaluation unit can be connected to the device either mechanically fixed or detachable, for example by a screw connection. In this context, the term “mechanically firmly attached” may mean an inseparable mechanical connection. It would be conceivable for the sensor and evaluation unit to be connected to the device, for example, by shear bolts that make unscrewing virtually impossible because the bolt head breaks off at a certain torque. This makes it almost impossible to unscrew this safety screw. The sensor and evaluation unit can also be connected to the device in a detachable manner. In any case, to prevent manipulation after the drive unit has been installed, it must be ensured that the sensor and evaluation unit cannot be disconnected from the drive unit without this being noticed. This can be ensured by an unbreakable connection. Alternatively, however, a detachable connection with additional measures may be provided. For example, a seal between the device and the sensor and evaluation unit attached to it and/or an electronic link of digital serial numbers of the corresponding components could be provided in order to obtain proof of (unauthorized) separation of the sensor and evaluation unit from the rest of the drive device if necessary.

Furthermore, according to the invention, the sensor and evaluation unit stores key data of the drive device in the form of an electronic type plate, in particular key data and/or motor data and/or drive parameters and/or serial numbers and/or manufacturer's designation and/or CE marking and/or usage history and/or alternative conformity information, and the sensor and evaluation unit is connected to the control and/or regulating device for sending and receiving data. The information regarding the usage history can include, in particular, variables that influence wear, such as the result of a cycle counter, the number of reversals or the like. Target limit values can also be stored as reference values.

The usage history is data that results from the use of the device, for example, the operating hours, the load, the number of hollow shaft rotations, as well as the reversal games or the hard and soft reversals or typical and maximum torques. In contrast to serial numbers, manufacturer designations, or CE markings, for example, this data is subject to constant change.

In particular, a memory with key data or a usage history stored in it can be firmly connected to the drive mechanism, in particular mechanically.

Preferably, the sensor and evaluation unit can be connected to the control and/or regulating device via a bidirectional data line.

The purpose of such an electronic control and/or regulating device is to activate the electric drive for the movement of the darkening, adjusting, or closure device, to process the signals from the control sensors for adjusting the darkening, adjusting, or closure device, to scan sensors for determining the position and to process this information, and to evaluate the signals from safety sensors and to control the drive in accordance with this information.

Due to the preferred fixed connection of the sensor and evaluation unit to the device, it is not possible to replace individual components without this being noticed. In particular, components that are subject to wear can be identified by their serial number or other key data. Their serial numbers can be stored in the sensor and evaluation unit. These components cannot be replaced without this being detected during a later comparison with the serial numbers stored in the sensor and evaluation unit. This is because the data stored in the sensor and evaluation unit, known as device fingerprints, recognize a different serial number or key data when components of the sensor and evaluation unit, such as processors, CAN distributors (controller area network distributors), sensors, etc., are replaced. It is also not possible to change the entire sensor and evaluation unit without detection, because the key data from the electronic components of the sensor and evaluation unit do not match the characteristics stored in the sensor and evaluation unit.

This ensures electronic tamper protection and would not allow any of the components to be replaced. A mechanical safeguard would be another-additional-safeguard against tampering due to this electronic type plate permanently stored in the drive unit.

The electronic type plate can store the individual data of the drive configuration and, in an extended design of the invention, also the serial numbers of the gearbox parts subject to wear and other drive-specific data. This makes it much easier to commission and for the gate control unit to recognize the system automatically.

The electronic type plate can also store “customer codes”, i.e., customer-specific data. For example, if a component is defective, only a replacement part from a specific manufacturer might be “approved”. Parts from other manufacturers would not work because the stored code does not match this “unauthorized” part.

The sensor and evaluation unit, which is preferably firmly attached to the device, is thus a captive data storage device.

The drive unit can be customized by storing data such as test stand data, certain characteristics, measurement data or the like, for example also as verification or “device fingerprint”.

Furthermore, indicators of the state of wear can also be derived for the entire darkening, adjusting, or closure device, for example a blind, door, or their parts, such as springs, bearings, rollers, shafts, from the data of the sensor and evaluation unit, e.g., due to unusual accelerations measured by an acceleration or vibration sensor. An acceleration or vibration sensor of this kind is an inertial sensor. Therefore, these terms are to be considered synonyms throughout the present application text. Gyro, vibration, or rotation sensors also fall under the category of acceleration or vibration sensors within the meaning of the invention. It is conceivable that several sensors are combined in a measuring unit, in particular in an inertial measurement unit.

Measuring unusual vibrations can indicate a defect or wear in the door system, wherein acceleration peaks and/or angular velocities are preferably evaluated. As mentioned above, such cyclic vibrations, especially high ones, can be caused by a deformation-or break-inducing impact that does not, however, cause the goal to crash (sudden overload due to an emergency or quick stop). These vibrations can be detected by suitable sensors, such as an acceleration or vibration sensor and/or an inertial measurement unit, in order to obtain information about the state of wear of gearing components. In particular, conclusions can be drawn about the state of the device before a possible breakage or destruction of the drive. However, it is also conceivable that a rupture event itself could be detected by the sensors.

As mentioned, for safety, cost, and sustainability reasons, the drive should be replaced or serviced when it reaches a defined wear limit, i.e., not too early and not too late. However, this requires knowledge of the current state of wear, which is achieved by the drive device according to the invention.

On the one hand, the invention monitors and qualitatively evaluates the quantitative limit values on which the design is based, wherein the limit values “inseparable” from the drive, which, for example, are stored in the form of the electronic type plate, which is stored during production, and corresponding measured values are stored as statistical values in the drive in electronic data. This data may include the number of opening and closing cycles, hard reversals, overspeeds/underspeeds, torque loads, etc.

Due to the design of the drive mechanism according to the invention, the drive system has more “intelligence” than known devices, in particular with regard to impending damage to the darkening, adjusting, or closure device, the blind, or the door in the vicinity of the drive, such as at the weld seams of the door shaft, with the aim of also detecting such damage—in addition to damage to the drive system itself—at an early stage.

It is also possible to detect defective drive bearings or a defective worm shaft as well as a defective door shaft or its bearing. It is also possible to detect defects in the torque arm and incorrect door operation due to mechanical tension or defective track rollers.

Known systems only react in the event of breakage, and only if selected gearing components of the drive system break, such as mechanical tooth breakage safety devices, so-called “gearbox breakage safety devices”. However, these mechanical safety devices cannot prevent other causes of falls, such as a holding brake failure.

Among other things, this error case is prevented according to the invention, as it would result in an immediate shutdown of the drive device and the associated darkening, adjusting, or closure device, which would mean unplannable and costly downtimes of the application. This can be realized with predictive maintenance and corresponding self-diagnostic functions of the drive unit. An acceleration or vibration sensor (inertial sensor) or an inertial measuring unit can therefore also be used for mechanical diagnostics of the overall application, e.g., a door construction. In particular, vibrations and shocks can be measured that indicate a defect in the drive and/or the darkening, adjusting, or closure device.

In addition and/or alternatively, typical wear variables such as oil loss and/or the degree of wear of the worm gear teeth and/or unusual vibrations and shock loads and/or torque loads are measured and evaluated using the electronic sensors and permanently stored in the drive device.

In addition, the solution according to the invention shortens the signal cable paths at the application and mechanically integrates the signal distribution device into the drive device, which is advantageous for reasons of cost and complexity.

According to a first advantageous embodiment of the invention, the drive device has a first brake which is operatively connected to the drive motor and which applies a holding torque to the darkening, adjusting, or closure device via the drive motor for braking and holding the darkening, adjusting, or closure device in a predetermined position, wherein it is possible to detect its state of wear by means of the sensor and evaluation unit and/or to control the first brake as a function of the data determined by the sensor and evaluation unit.

This first brake can be designed as a permanently acting or electromechanically switchable or electromagnetically switchable brake. In particular, drive devices that do not have a first brake, such as balanced doors without a brake, are conceivable. In other applications, however, the first brake can be provided.

The electromechanical brake can be open as long as it is supplied with electrical voltage, i.e., the drive motor can rotate freely for this long.

As soon as their supply voltage is interrupted, the brake starts to work. These brakes work according to the so-called closed-circuit current principle. However, there are also known brakes that work according to the so-called working current principle, which become active as soon as they are supplied with their supply voltage.

The brake can have an integrated frequency converter or be powered by a switching power supply.

It is also conceivable that the brake is directly connected to the gearbox.

According to an advantageous further development of the invention, the sensor and evaluation unit has a position signal transmitter, preferably with unlimited rotation, with a position detection sensor for detecting the position and/or speed and/or direction of rotation of the darkening, adjusting, or closure device, irrespective of the number of revolutions, and/or a wear sensor for direct wear measurement, in particular of at least one gear wheel of the gearbox and/or an acceleration or vibration sensor (inertial sensor) and/or an inertial measuring unit and/or a motor temperature sensor and/or an oil level sensor and/or a sensor for detecting brake release and/or a sensor for detecting emergency actuation.

The inertial measurement unit usually has several sensors, for example at least one acceleration or vibration sensor and at least one angular rate sensor. However, it is also conceivable that the unit only has one sensor, for example a (single) acceleration sensor or a (single) rotation rate sensor.

In particular, in order to detect the six possible kinematic degrees of freedom, the inertial measuring unit can have three acceleration sensors (translation sensors) that are orthogonal to each other for detecting the translational movement in the x-, y-, or z-axis and three angular rate sensors (gyroscopic sensors) that are orthogonal to each other for detecting rotating (circular) movements in the x-, y-, or z-axis. The unit can therefore provide three linear acceleration values for the translational movement and three angular velocities for the rotation rates as measured values.

This inertial measuring unit measures accelerations and angular velocity on the gearbox so that unusual angular velocities or accelerations, for example due to a defect in a gearing component, can be reliably detected. As a result of the detection, the drive unit can be shut down, also to prevent the breakage of further teeth of the gearbox teeth and a possible door crash.

The sensor and evaluation unit can be used to determine the wear condition for the entire drive device and/or indicators for the wear condition of the darkening, adjusting, or closure device.

In particular, the acceleration or vibration sensor (inertial sensor) and/or the inertial measuring unit can be used to measure the accelerations on the drive motor and compare them with predefined values. Unintentional accelerations can also be caused by a fault in the design of the darkening, adjusting, or closure device, in particular of a door, for example a slowly failing weld seam of the door shaft hub or parts of the curtain that tilt or other mechanical damage, for example to a door frame. The acceleration or vibration sensor and/or the inertial measurement unit can therefore also be used for mechanical diagnostics of the overall application, e.g., a door construction. In particular, vibrations and shocks can be measured that indicate a defect in the drive and/or darkening, adjusting, or closure device.

In addition and/or alternatively, typical wear variables such as oil loss and/or the degree of wear of the worm gear teeth and/or unusual vibrations and shock loads and/or torque loads are measured and evaluated using the electronic sensors and permanently stored in the drive device.

The mechanical integration of the corresponding sensors and the evaluation electronics, their positioning with regard to the measurement signal quality, their thermal load, and ease of assembly in drive production are of decisive importance here. It must also be ensured that the sensor and evaluation unit is permanently connected to the drive and cannot be replaced undetected. The sensor and registration unit can also be referred to as an “electronic data collector”.

According to an advantageous embodiment of the invention, the position detection sensor detects the number of rotations and/or rotation angles by means of a magnetic field sensor and a permanent magnet arranged on the shaft of a toothing component, in particular a gear wheel or worm gear.

For example, according to EP 1 617 180 B1, the position of a rotatable shaft can be determined with an AMR sensor unit or GMR sensor unit, in which a magnet arranged on a shaft to be monitored is provided for position detection. The position encoder can be used as a singleturn and multiturn encoder at the same time. The position signals can only be derived from the signals of the AMR or GMR sensor unit.

This contactless detection of revolutions also has the advantage that high speeds can be detected and that a long mechanical service life is achieved even in harsh environments.

In addition, the values of the sensor and evaluation unit can be actual values and reference values for the dynamic holding torque of the gearbox and/or for the braking force of the brake and/or the change in the dynamic holding torque of the gearbox and/or the change in the braking force of the brake.

Other conceivable input variables could be the number of hollow shaft revolutions per cycle, the speed or the oil temperature. The oil viscosity can be deduced directly from the oil temperature. It is also conceivable to determine the sliding speed when gearing the gearbox components. The wear condition of gearing components can also be determined from this.

The detection of the position of the darkening, adjusting, or closure device independent of the number of revolutions according to the invention is advantageous compared to the known position detection systems. This is because separately driven position encoders—i.e., driven via a separate drive shaft that is not in the power flow—are currently widespread. These are each designed for only a certain number of revolutions between the start and end position and reduce the flexibility of the drive application accordingly. Also state of the art are separately available, continuously rotating angular position detection systems, for example multiturn position sensors with a backup battery, which can also be mounted separately on the darkening, adjusting, or closure device of the drive application, for example a door system.

According to an advantageous embodiment of the invention, the sensor and evaluation unit has indirect wear detection with at least one cycle counter, in particular at least one weighted cycle counter, which determines at least the input variable torque and/or number of revolutions per cycle and in particular uses it in a weight model.

In particular, the cycle counter provided in the sensor and evaluation unit can be used to determine the data and store it in a memory for the usage history.

This indirect wear measurement using cycle counters or weighted cycle counters can be regarded as a preliminary stage to direct wear measurement. For example, a drive can be designed for 1 million cycles so that the cycle counter outputs a corresponding signal when this number is reached, indicating that the maximum service life has been reached. In the case of a weighted cycle counter, the different load on the drive could be taken into account, for example, when driving up with a load compared to driving down in the drive, so that the maximum running performance increases over the 1 million cycles and only then is a corresponding signal output. This means that the drive can be used for longer and therefore more sustainably and efficiently.

In the simple embodiments of the sensor and evaluation unit according to the invention, the wear is merely estimated and compared with model calculations. In the extended embodiments of the sensor and evaluation unit according to the invention, the wear is determined directly, for example by a sensor that directly measures the wear of gearbox components, such as a worm gear of the gearbox.

In a particularly advantageous further development of the invention, output means are provided by means of which the state of wear of at least one part of the drive device and/or darkening, adjusting, or closure device can be output.

Due to the output means for outputting a wear condition, excellent diagnostics of the drive device is possible. This information can, for example, be output directly on the device, in particular via a display, optical or acoustic signals, or via interfaces to which readout devices such as computers can be connected. It is also conceivable to output the wear status of drive components wirelessly, for example on smartphones or tablets.

For example, an authorized person can access the sensor and evaluation device via an interface and configure the corresponding output options.

The entire drive unit and any other components, such as light grids, can be controlled via a BUS system.

Status LEDs can be provided on the drive device to indicate operating or error states. Further information about the drive unit can also be shown on the display. The display can, for example, be arranged on the drive device or on the control and/or regulating device.

For example, LEDs on the light grid and/or on the sensor for object/person detection can indicate error states detected by the sensor and evaluation unit.

The door control display can be mirrored on an external operating unit. The external operating unit is a sub-unit of the drive unit. It can be connected directly to the drive device, in particular to the connection module, by means of cabling. The central cabling reduces the number of cables.

It is also conceivable that devices such as a signal light or a display for showing the status of the darkening, adjusting, or closure device, for example a door status, are connected.

This signal display or application components can also be used to display the status of the light grids, for example “one beam defective” or “light grid active” or similar.

A particularly advantageous embodiment of the invention is one in which the drive device has at least one second brake, in particular an electronic anti-drop device for braking and holding the darkening, adjusting, or closure device. In the event that the first brake fails, a holding torque is built up on the darkening, adjusting, or closure device via the drive motor, in particular by building up a torque of the drive motor that is opposite to the unauthorized direction of movement. In particular, a torque opposite to the detected, unauthorized running direction can be built up, which represents a holding torque after the movement has stopped.

The unauthorized direction of movement of the drive motor refers to the direction of movement that is not desired for an intended function.

This “second brake”, which is redundant to the first brake, is software-controlled, in particular depending on the data from the sensor and evaluation unit. It is particularly advantageous here that a braking function is performed by means of the drive motor, whereby the electronic switch-off device and fall protection are realized.

This “electronic anti-drop device” thus closes the safety gap that cannot be closed by the well-known and established tooth breakage safety devices (so-called “gearbox breakage safety devices”), as these require damage to a gearbox component, for example tooth damage or tooth breakage, in order to be triggered.

However, the failure of the electromechanical holding brake, i.e., the first brake, can—as documented cases show—cause the darkening, adjusting, or closure device, for example a door, to fall even if the gearbox is completely intact. Established tooth fracture safety devices therefore have nothing to counter this safety risk.

The electronic fall protection system can have a frequency converter that reduces the drive motor to zero speed, i.e., stops the movement of the motor. The drive device therefore has a safety concept with two redundant brakes, which are based on different modes of action or have different components, which further reduces the risk of the darkening, adjusting, or closure device, for example a blind or a gate, falling.

In terms of the invention, it is also conceivable that the “second brake” (electronic fall protection) controlled by the power electronics is the only brake of the device, i.e., that a “first brake” need not be provided, for example in the case of spring- or weight-balanced gates, in particular in applications for currentless opening, spring-biased gates (escape gates).

The “second brake”, which is redundant to the first brake and reacts more quickly, significantly increases system safety in the drive system in the event of a fault, but without increasing the installation space and at the same time making it economically viable.

In particular, it may be provided that the electronic fall protection system can be controlled by means of a signal detected by the sensor and evaluation unit, for example that the sensor and evaluation unit detects a failure of the holding brake and in this case transmits a signal to the electronic fall protection system to build up a torque of the drive motor connected to the electronic fall protection system that is opposite to the unauthorized direction of movement.

The electronic fall protection system is designed so that it can also be used with standardized motors. If the first holding brake fails, the sensor system detects an unauthorized movement of the motor shaft. In fractions of a second, the drive motor is instructed to build up a counter-torque and thus temporarily take over the holding function of the—inoperative—first holding brake, thus preventing the load from falling. In particular, the darkening, adjusting, or closure device, for example a blind or a gate, can be lowered in a controlled manner after warnings have been issued, thus preventing serious injuries or fatalities.

According to a further advantageous embodiment of the invention, it is provided that the sensor and evaluation unit is arranged on a housing section of the device, in particular of the gearbox, and/or forms a housing section of the device, in particular of the gearbox, wherein the housing section has an opening which can be closed by means of a housing section lid and/or a connection and maintenance access.

As mentioned, the sensor and evaluation unit is connected to the drive device, in particular it can be mechanically fixed. For this purpose, the sensor and evaluation unit can in particular be arranged on a housing section of the gearbox and/or form a housing section of the gearbox. The housing section can also be used in other ways by having an opening that can be closed by means of a housing section lid and/or a connection and maintenance access.

It may also be provided that the housing for the gearbox forms a bearing point for the darkening, adjusting, or closure device, in particular for a winding shaft of the darkening, adjusting, or closure device.

This design ensures that the sensor and evaluation unit is mechanically fixed to the drive device and that individual components cannot be replaced. Components subject to wear in particular can be identified via the corresponding serial number or other key data. Subsequent manipulation of the drive, e.g., replacing a worn gear wheel with a new one, would therefore be detected during a diagnosis because the serial number stored in the sensor and evaluation unit and the serial number lasered onto the gear wheel, for example, do not match.

The housing is advantageously made of plastic. This means that the housing can be manufactured at very low cost. It is also possible to use another non-ferromagnetic material. The device according to the invention has the advantage that the housing, if it is made of plastic, is inexpensive, and can be manufactured in complex shapes. It is corrosion-resistant, lightweight and highly leak-proof. It also has the advantage that there is poor heat transfer, for example from a hot drive motor to the electronics.

A further advantage of the housing is that the encapsulation of the sensor unit means that there is no influence from dust, moisture, grease, oil, and the like.

According to a particularly advantageous variant of the invention, the sensor and evaluation unit has at least one, preferably interchangeable, connection module with at least one connection port for connecting signal and data lines, wherein the connection module can in particular be detachably connected to the housing section.

In particular, the connection module can be plugged in or unplugged. It is interchangeable, in particular of modular design and can be cascaded with external modules of the same function. This ensures local separation of power and data/sensor connection points, which is advantageous for reasons of electrical safety and electromagnetic compatibility (EMC). Until now, these connection points on the drive have been offered in one and the same connection housing.

This design significantly increases configuration flexibility. Depending on customer requirements, data distributors can be designed with 0, 2, 4 . . . 10 data ports (plug connections), for example. In the case of zero ports, it is simply a lid that forms the sealing surface for maintenance access.

In particular, it can be provided that the connection module is designed as a closure and sealing element for the housing section and preferably has a connection and maintenance opening that can be closed with a lid.

In particular, a separate seal can be provided between the connection module, which is designed as a closure and sealing element, and the housing section.

A further advantage of the invention is that if a housing lid is provided, it can also be opened “in the field”, as the electronics are insensitive to dirt, moisture, and so on. This has the advantage that parts of the connection module or, for example, a battery can be easily replaced without any additional mechanical effort. Furthermore, terminals can be designed to be pluggable inside the housing so that no expensive and sealed special connectors need to be used.

According to an advantageous further development of the invention, the drive device has an emergency actuation device for manual actuation of the drive shaft of the drive motor, preferably by means of a crank or chain hoist, in the event of failure of the drive motor.

In the event of a power failure, the emergency actuation device is used to rotate the drive shaft of the motor manually using a crank, in particular a hand crank or a chain hoist. In the example of a door system as a darkening, adjusting, or closure device, the door can also be opened manually.

According to an advantageous variant of the invention, an emergency actuation switch is provided for detecting a hand crank inserted into a corresponding receptacle of the emergency actuation device, so that the sensor and evaluation unit can then be used to prevent the drive or electric motor from rotating in this case after unexpected termination of the de-energized state, which would then cause the hand crank or an engaged chain hoist emergency operation module to rotate as well, which could lead to injuries to the operator.

The emergency actuation itself is passive in this case. It cannot be controlled directly, as confirmation is done manually. On the other hand, when the crank is inserted into the emergency actuation housing, the emergency actuation switch, preferably located in the housing, can be actuated by the crank shaft. Triggering this switch prevents the drive motor from being energized while the crank handle is inserted, so that it is not inadvertently turned by the energized drive motor and torn out of the operator's hand. The emergency actuation device therefore has an additional safety feature.

In other words, when the emergency actuation is used, the emergency actuation switch is actuated either by inserting the hand crank or separately by pulling on a switching cable, thereby triggering an EMERGENCY OFF. The reason for this is to ensure that no one can press the “Open door” button during manual operation and pull the crank or chain hoist out of the operator's hand if the door then immediately opens electrically. The switch in the emergency actuation is therefore a breaker that is installed in the emergency stop chain and thus sets the door system to emergency stop.

According to an advantageous embodiment of the invention, the drive device has a connection device for the electrical energy, wherein the connection device has, in particular, a plug connection for connecting the electrical energy. Preferably, at least one connection cable has a part of the plug connection, in particular a plug with plug housing, which can be plugged into a corresponding mating plug on the drive device.

A connection cable of the connection device can have a housing designed as a plug part in order to establish a simple and secure plug connection. In particular, high and low voltage can be physically separated for safety reasons. This also significantly improves electromagnetic compatibility (EMC). One part of the plug connection can be designed as a housing, which is part of the cable set, i.e., the cable set is already arranged on a housing section or a box, which is simply plugged onto a corresponding counterpart on the drive device. This housing therefore fulfills a dual function. This is because it serves both as an electrical connection and as protection against injury from the electrical contacts. Thanks to the plug-in connection, a simple connection is possible without complex assembly.

Furthermore, there is no need to use expensive and sealed special plugs.

Due to this advantageous embodiment of the invention, easy installation of the signal and power cables as well as special installation ergonomics. Observations from everyday assembly work have also shown that the drive is often gripped by the safety-relevant holding brake or even by its cable connection with one of the two hands during assembly. To prevent this and at the same time provide protection for the equally safety-relevant brake control cable, the invention has an ergonomically shaped lifting aid and cable protection cover in an advantageous embodiment, which is firmly connected to the gearbox.

The drive device can be located several meters up within the darkening, adjusting, or closure device. Due to this installation situation, possibly exacerbated by the need for overhead work and possibly poor lighting, special requirements are placed on the captive nature of fastening elements (e.g., screws) or housing sections (e.g., assembly opening lids), as well as on the type of contact (preferably pluggable connections as opposed to those that require on-site screwing).

These requirements make it necessary to integrate housing sections of the invention into the cable harness and to pre-assemble them into the cable harness in order to avoid complicated on-site feed-through of the connectors through openings in the housing. This means that costly assembly errors, such as incorrect contact, loss of the sealing effect due to damage to sealing elements, or loss of fastening elements, etc. due to an ergonomically unfavorable assembly situation, are already conceptually ruled out. At the same time, tool-free installation of the signal and power lines shortens and simplifies commissioning.

According to an advantageous embodiment of the invention, it is provided that the first brake is arranged on the drive motor by means of a holding and cooling device, and the holding and cooling device preferably has at least one laterally arranged intake air inlet for drawing in ambient air for cooling the drive motor and preferably a contact surface for, in particular, flat contact or for flat mounting of the first brake on the drive motor.

The motor ventilation provides an additional safety function to prevent the drive system from overheating. It can be designed in such a way that, despite the axial mounting of the holding brake, it can draw in sufficient air in the air flow behind the fan wheel and allow it to flow over the motor. In this solution, the fan wheel has the shortest possible distance from the (hot) motor end shield and is not obstructed by a holding brake in front of it. The fan housing can be equipped with intake openings in the surface perpendicular to the motor axis or in a funnel-shaped surface of the holding and cooling device.

In the version with intake openings in the surface perpendicular to the motor axis, the first brake is mounted on spacer bars provided for this purpose, which meet the strict planarity and orthogonality requirements of the first brake, in order to allow the intake air to enter from the side. With the invention, this solution can easily be realized with widely used standard motors with a maintenance-friendly accessible holding brake that is visible from the outside. The fan guard used by the standard motor manufacturer can be dispensed with and replaced by that of the invention.

The motor cooling system can be designed in such a way that it has a laterally arranged air intake inlet for a temperature reduction of at least two degrees Kelvin compared to the passive case and/or has the necessary planarity and orthogonality requirements for the brake connection. Due to this cost-optimized and operating time-reduced design of the invention, more efficient cooling of the motor is possible with simultaneous accessibility of the first brake from the outside.

Furthermore, overheating is prevented for a certain duty cycle of the drive under load.

The drive device can be fastened by means of an elastically decoupled fastening means, in particular a fastening foot, especially on the building side.

Mounting the first brake on the motor side is therefore demanded by the market solely for the reason of the limited installation space in direction (A), which, however, rules out active air cooling of the motor and gearbox by the motor fan usually arranged on the motor B side, as this would be covered by the first brake.

This problem is circumvented with integrated brakes on the B-side, which also represent the state of the art. However, these solutions have the decisive disadvantage that ventilated, standardized standard motors cannot be used and visual and maintenance access to the safety-relevant holding brake is not possible without dismantling the fan housing, as it is enclosed by the fan housing. Finally, these solutions place the brake in the cooling air flow of the fan, which prevents a direct, more efficient flow to the motor B end shield and the motor cooling fins. As brake cooling is not required for many applications, e.g., applications with intermittent operation, such as door systems, the arrangement of the brake within the fan housing merely represents an obstruction to the cooling air flow.

Passively cooled drives without active ventilation are therefore mainly found in widespread use in the door industry. As the fan is mounted on the—already rotating—motor shaft, this cooling capacity is available with negligible additional drive power. This cooling capacity is currently dispensed with mainly for reasons of installation space, as the brake must be fitted on the motor side in order to comply with the installation space restriction in direction (A) and—without the features of the invention—would hinder active ventilation as described above or make it impossible if the fan openings were completely covered.

The resulting omission of active ventilation and/or for cost reasons in turn results in a significantly lower, maximum possible, uninterrupted running time of the drive under load. Attempts are being made to counteract this by oversizing the drive, with the associated waste of resources and energy. Alternatively, the brakes are mounted on the gearbox side, which means that they can only be used in strictly limited installation spaces, which is of course also an unsatisfactory situation for the door industry.

The holding and cooling device of the invention solves all these problems and shortcomings, while providing an additional safety function to prevent the drive system from overheating. It is designed in such a way that it can draw in sufficient air in the air flow behind the fan wheel and let it flow over the motor despite the axial mounting of the first brake. In this solution, the fan wheel has the shortest possible distance from the (hot) motor end shield and is not obstructed by a holding brake in front of it.

The fan housing can be equipped with intake openings in the surface perpendicular to the motor axis or in the funnel-shaped surface of the holding and cooling device.

Finally, the drive device can have a sensor for monitoring the manual brake release, in particular a proximity sensor, preferably connected to the sensor and evaluation unit, for detecting the mechanical movement of a brake release lever. This is a necessary function in order to be able to move the darkening, adjusting, or closure device manually.

It is also conceivable that at least one signal display is provided for signaling the operating state of the drive device and/or for signaling the wear state of at least one part of the drive device and/or the darkening, adjusting, or closure device. For example, the states “Error”, “Ready for operation”, “Supply OK” etc. could be signaled using the signal displays on the drive.

In a further embodiment of the invention, the position is detected via a position encoder shaft arranged essentially perpendicular to the motor shaft axis in the gearbox, wherein the position encoder shaft is guided into the sensor and evaluation unit and can be driven by the gearbox drive shaft, which is preferably designed as a worm shaft.

Further objectives, advantages, features, and applications of the present invention are derived from the subsequent description of an exemplary embodiment by way of the drawings. All described and/or depicted features, per se or in any combination, constitute the subject-matter of the present invention, regardless of their summary in the patent claims or their back-reference.

### DESCRIPTION OF THE DRAWINGS

Partially schematically, the drawings show in:

FIG. 1 a first embodiment of a drive device in perspective view,

FIG. 2 a side view of the drive device as shown in FIG. 1,

FIG. 3 the drive device according to FIG. 1 in combination with a darkening, adjusting, or closure device, and

FIG. 4 a second embodiment of the drive device.

Identical or identically functioning components are provided with reference numerals based on an embodiment in the subsequently depicted figures of the illustration in order to improve readability.

### DETAILED DESCRIPTION

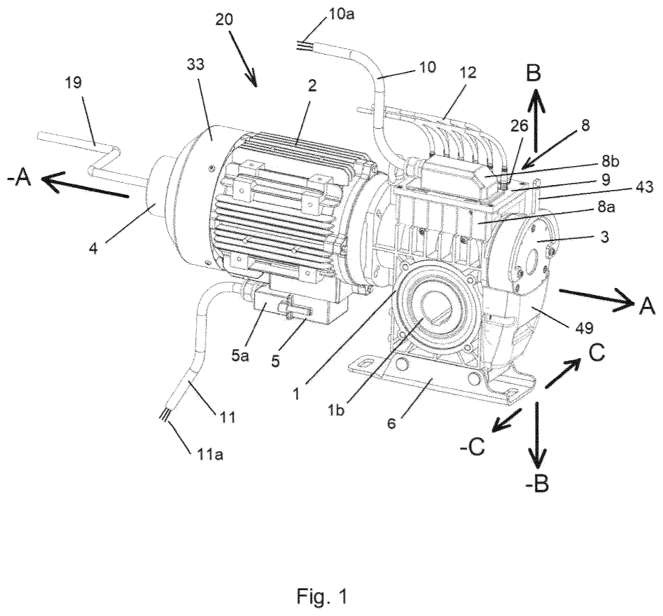

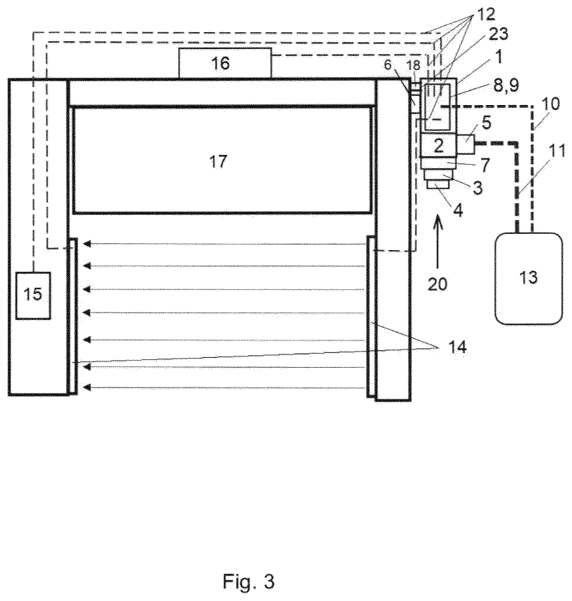

FIG. 1 shows a drive device 20 for moving a darkening, adjusting, or closure device 17, in particular in the form of a blind, roller shutter, garage door, roller shutter, room divider, smoke protection curtain, sliding door, folding door, slats, an adjustable working platform or the like. Such a darkening, adjusting, or closure device 17 is shown schematically in FIG. 3.

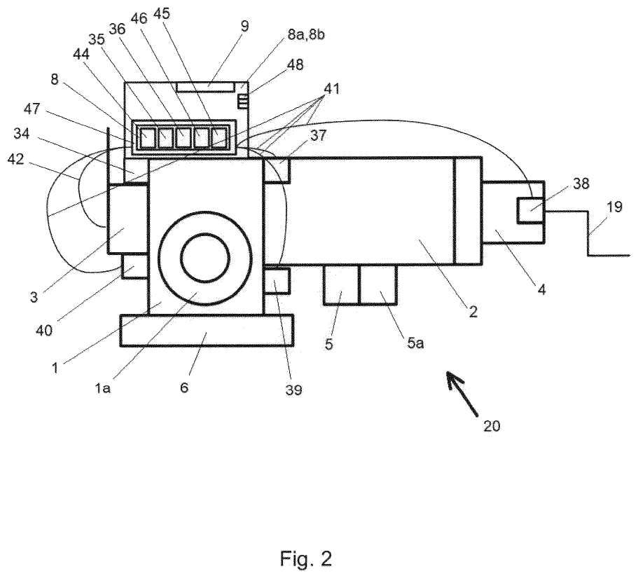

FIG. 2 shows a schematic side view of the drive device 20.

Furthermore, according to FIG. 1 and FIG. 2, the drive device 20 has a drive or electric motor 2 that can be driven by means of an electric drive signal to move the darkening, adjusting, or closure device 17. The drive motor 2 has a motor controller connected to a control and/or regulating device 13 for controlling the darkening, adjusting, or closure device 17 or is connected to such a device. This motor control is not shown.

FIG. 1 also shows that a gearbox 1, in particular a worm gearbox, is arranged in the drive train between the output shaft of the drive motor 2 and the drive shaft 18 of the darkening, adjusting, or closure device 17. FIG. 2 also shows a drive gear 1a, in particular a worm gear of the gearbox 1.

The drive shaft 18 of the darkening, adjusting, or closure device 17 is connected to the output shaft 1b of the gearbox 1, in this example designed as a hollow shaft with a keyway. This drive shaft 18 forms a bearing point 23 of the darkening, adjusting, or closure device 17, as can be seen in FIG. 3.

FIG. 3 shows in particular the darkening, adjusting, or closure device 17, which in the present case is designed as a door, for example an industrial door. The drive device 20 is operatively connected to a winding shaft of the door. Light grids 14 for detecting an obstacle can also be seen.

In the present case (see FIG. 3), the drive device 20 itself is connected to the door system with an elastically decoupled fastening foot 6, a so-called pendulum foot. The drive motor 2, which is designed as an electric motor, provides the required torque and motor speed. In the subsequent gearbox 1, the motor speed is reduced by one or more gear stages, for example, and the torque is increased, for example.

As FIG. 1 further shows, the device 20 has a sensor and evaluation unit 8 connected to the device 20 for diagnosis and evaluation, in particular for determining a state of wear of the drive device 20 and/or the drive motor 2 and/or the gearbox 1 and/or a first brake 3 and/or the darkening, adjusting, or closure device 17.

Data of the drive device 20 can be stored in the sensor and evaluation unit 8 in the form of an electronic type plate 45, in particular key data and/or motor data and/or drive parameters and/or serial numbers and/or manufacturer designation and/or CE mark and/or usage history and/or alternative conformity information. The sensor and evaluation unit 8 is connected to the control and/or regulating device 13 to send and receive data.

The usage history is data resulting from the use of the device, for example the operating hours, the load, the number of hollow shaft revolutions, and the number of reversing cycles or hard and soft reversals or typical and maximum torques. In contrast to the serial number, manufacturer's designation or CE mark, for example, this is therefore dynamically variable data.

The first brake 3, which is operatively connected to the drive motor 2, applies a holding torque to the darkening, adjusting, or closure device 17 via the drive motor 2 in order to brake and hold the darkening, adjusting, or closure device 17 in a predetermined position.

This electromechanical first brake 3 prevents unauthorized rotation of the motor shaft. Using the example of a door application as a darkening, adjusting, or closure device 17, the door is held in the upper end position. The first brake 3 can be designed to be normally closed or normally open.

It is particularly advantageous that the wear condition of the brake 3 can be detected by means of the sensor and evaluation unit 8. In addition, the first brake 3 can be actuated depending on the data determined by the sensor and evaluation unit 8.

In the event of a power failure, an emergency actuation device 4 is used to rotate the drive shaft of the drive motor 2 manually, for example with a crank 19, preferably a hand crank, as shown in FIG. 1, or a chain hoist. In the example of a door system as a darkening, adjusting, or closure device 17, the door can also be opened manually.

The emergency actuation device 4 can be controlled using the data determined by the sensor and evaluation unit 8. The emergency actuation is a manual movement of the drive shaft of the drive motor, in particular the electric motor 2. However, an emergency actuation switch 38 can detect whether the hand crank 19 is inserted into a corresponding receptacle of the emergency actuation device 4, so that the sensor and evaluation unit 8 can then prevent the drive or electric motor 2 from rotating in this case after unexpected termination of the de-energized state, as a result of which the hand crank 19 would also be rotated, which could lead to injuries to the operator (see FIG. 2).

In the present exemplary embodiment, the drive device 20 has a second brake, which is designed in particular as an “electronic fall protection” in the drive system using the existing electric motor 2. For this reason, the drive or electric motor 2 itself can also be referred to as the second holding brake.

When the second brake is activated, a holding torque is built up on the darkening, adjusting and closure device 17 by building up a torque of the drive motor 2 that opposes the unauthorized direction of movement.

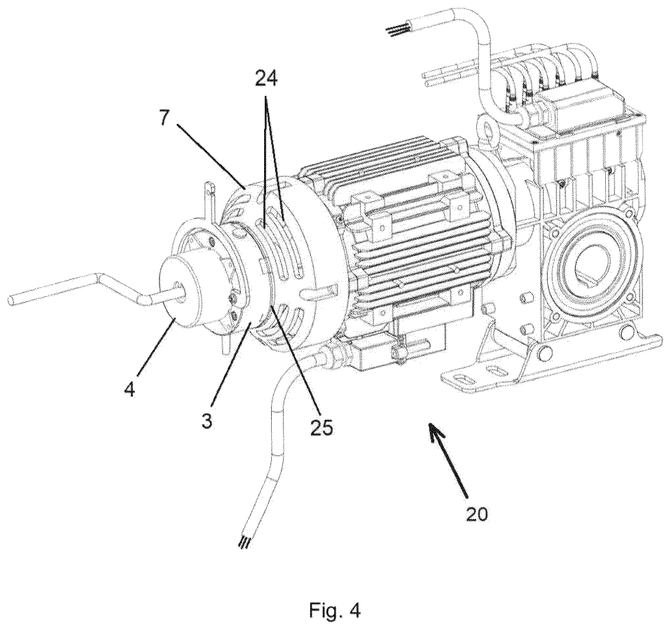

In the event that a customer is confronted with the described installation space limitations in direction A (see FIG. 1), the invention can also be equipped with a holding brake on the motor side (see FIG. 4), albeit using the modified fan guard 33 described there and accepting the fact that the holding brake cannot then counteract a motor shaft breakage.

The so-called “electronic anti-drop device” closes the safety gap that cannot be closed even by known tooth breakage safety devices (so-called “gearbox breakage safety devices”), as these require damage to a gearbox component, for example tooth damage or tooth breakage, in order to be triggered. However, as documented cases show, the failure of the electromechanical first brake 3 can cause the door to crash even if the gearbox is completely intact.

The electronic fall protection system is designed so that it can also be used with standardized motors.

The electronic fall protection system can be activated by means of a signal detected by the sensor and evaluation unit 8. The sensor and evaluation unit 8 detects a failure of the first brake 3 and in this case transmits a signal to the electronic anti-drop device to reverse the torque and thus stop the unauthorized movement of the drive motor 2 connected to the electronic anti-drop device.

In other words, the sensor system of the sensor and evaluation unit 8 detects an unauthorized movement of the motor shaft if the first brake 3 fails. In fractions of a second, the drive or electric motor 2 is instructed to build up a counter-torque and thus temporarily take over the holding function of the—inoperative—first brake 3 and thus prevent the load from falling. This gives the darkening, adjusting, or closure device 17 the opportunity to lower the load in a controlled manner after warnings have been issued, thus preventing serious injuries or fatalities.

As can be seen from FIGS. 1 and 2 and also from FIG. 4, the sensor and evaluation unit 8 is arranged on a housing section or base housing 8a of the device 20, in particular of the gearbox 1. It is also conceivable that the sensor and evaluation unit 8 forms a housing section 8a of the device 20, in particular of the gearbox 1. In a particularly advantageous manner, the housing section 8a has a connection and maintenance access 8b.

Two printed circuit boards are provided in the base housing 8a. The main circuit board contains the sensors and evaluation electronics or parts thereof, which are installed once and do not need to be regularly accessible. A further board, arranged perpendicular to this one, for example, is used exclusively for connecting the data and control cable and for connecting to the main board.

In the present exemplary embodiment, the sensor and evaluation unit 8 can have an electronic module, which in turn is divided into two sub-modules. An electronic sub-module contains the sensors and evaluation electronics. A further electronics submodule is used exclusively to connect the data and control cable of the control and/or regulating device 13 and to connect it to the first electronics module. In addition, the first electronic submodule also includes a communication unit 47, via which it is connected to the control and/or regulating device 13.

A cover or a connection and maintenance access 8b can be opened without tools for a convenient, e.g., pluggable cable connection of the data and control line of the drive control, as well as for any necessary replacement of the battery, which keeps the electronic components of the sensor and evaluation unit 8 under the necessary voltage even in the event of a power failure.

The arrangement and alignment of the temperature-sensitive battery are of particular importance here. This is arranged within the base housing 8a of the sensor and evaluation unit 8 at the greatest possible distance from the heat sources during operation, for example vertically.

The cover or the connection and maintenance access 8b is part of a signal line 10 and is already pre-assembled on it. The cover 5a is also part of a power line 11 and is already pre-assembled on it. This eliminates the need for a complicated and error-prone feed-through of the cable connectors through the cover or the connection and maintenance access 8b on site or the otherwise alternative on-site assembly of the individual cable cores 10a at the contact points of the circuit board within the base housing 8a or the cable cores 11a of the power line 11 at the contact points of a connection device 5, as FIGS. 1 and 2 further show.

This pre-assembly of the connection device 5 and the connection and maintenance access 8b as well as the plugs on the lines 10, 11 under constant, controlled assembly conditions in the factory is what makes simple and secure pluggable cabling possible in the first place, but requires a fundamentally different housing layout compared to the state of the art.

This avoids possible mix-ups of the cable cores, contacting errors, damage to seals of the feed-through and housing elements due to an often unfavorable, possibly poorly illuminated installation situation at height, combined with any overhead installation work that may be required, right from the outset.

In addition, the plug connectors are connected to the cable cores 10a and 11a in a non-destructive manner (e.g., screwed) in order to provide the option of removing the cable connectors and the covers 5a and 8b from the respective lines 10, 11 in the rare case of more complex cable routing within the darkening, adjusting, or closure device (e.g., with narrow wall lead-throughs).

The lines 10 and 11 together with covers 5a and 8b and the connector solution described are part of the invention. The data lines 12, on the other hand, are only shown in FIG. 1 to visualize their connection.

As can also be seen from FIG. 1, the drive device 20 has, as mentioned, the connection device 5 for the electrical energy, wherein the connection device 5 has, in particular, a plug connection for connecting the electrical energy. In the present case, at least one connection cable is part of the plug connection.

The elements that connect the cover 5a to the connection device 5 and the connection and maintenance access 8b to a connection module 9 also do not require any tools. The permanent connection is made, for example, via clamping or sliding/clamping elements or combinations of these, which can only be locked or unlocked with the hands. This considerably simplifies, shortens, and ergonomically improves assembly.

Observations from everyday assembly work have also shown that the drive is often gripped by the safety-relevant holding brake 3 or even by its cable connection with one of the two hands for carrying during assembly. To prevent this and at the same time provide protection for the equally safety-relevant cable of the brake control 42, in one advantageous embodiment the invention has an ergonomically shaped cover and lifting aid 49, which in the present case is firmly connected to the gearbox 1.

The sensors contained in the sensor and evaluation unit 8 detect the position, e.g., of the motor shaft, as well as measured values that can be used to draw conclusions about the wear condition of the gearbox 1 or other components of the drive device 20, such as the darkening, adjusting, or closure device 17.

The position can be detected via a position sensor shaft in the gearbox 1 arranged perpendicular to the motor shaft axis, which is guided into the sensor and evaluation unit 8 and which is driven by the gearbox drive shaft (e.g., designed as a worm shaft) rotating at motor speed, but is not in the power flow.

In an alternative embodiment of the invention, however, the position detection can also be realized by a signal transmitter mounted directly on the drive shaft of the motor or on one of the gearbox shafts, e.g., the worm shaft or the hollow shaft 1b, rotating without limit, and a stationary receiver connected to the sensor and evaluation unit.

As shown in particular in the schematic representation according to FIG. 2, the sensor and evaluation unit 8 has a position signal transmitter, preferably with unlimited rotation, with a position detection sensor 34 for detecting the position of the darkening, adjusting, or closure device 17 independently of the number of revolutions and/or a wear sensor 40 for direct wear measurement, in particular of at least one gear wheel of the gearbox 1 and/or an acceleration or vibration sensor 36 and/or an inertial measuring unit and/or a motor temperature sensor 37 and/or an oil level sensor 39. FIG. 2 shows the wiring of the sensors 41 and the wiring of the first brake 42.

The position detection sensor 34 detects the number of rotations and/or rotation angles by means of a magnetic field sensor and a permanent magnet arranged on the shaft of a toothing component. The permanent magnet can be attached to a shaft of the gearing component as well as to a gear or worm gear itself. The permanent magnet can also have more than one north and south pole and can also be ring-shaped, for example.

Further sensors can measure physical quantities such as temperatures of the motor and gearbox, accelerations, or shock loads on the drive or changes in the tooth gap width of the gearing components. Downstream processors on the main board process this data using application-specific software and make it available at interfaces, e.g., for the control and regulating device.

In a preferred embodiment of the invention, it is equipped with sensors for position detection 34, for detecting the ambient temperature with an external temperature sensor 35, for detecting vibrations of the drive (acceleration or vibration sensor 36) and the oil level 39. The last two sensors allow immediate conclusions to be drawn about impending signs of wear. This enables the market demands for “predictive maintenance” and “self-diagnostic capability of the drive” to be met.

The worm gear of the worm gearbox is particularly critical for a possible gate crash. This is because the teeth on the worm gear are design-related, constructive wear parts, since the soft material of the worm gear usually rubs against the hard material of the worm shaft.

The worm gear is therefore already heavily and almost evenly worn due to frequent use. A sudden overload on the gearbox, for example due to an emergency or quick stop, can create a shock that can exhibit high, cyclic vibrations.

Such an impact can cause gradual damage or destruction of the gearing components.

These vibrations are detected by the acceleration or vibration sensor 36 according to the invention, in order to obtain information about the state of wear of the gearing components. In particular, conclusions can be drawn about the state of the device before a possible breakage or destruction of the drive. However, it is also conceivable that a fracture event itself could be detected by

An acceleration or vibration sensor 36 of this kind is an inertial sensor. Gyro, vibration, or rotation sensors also fall under the category of acceleration or vibration sensors within the meaning of the invention. It is conceivable that several sensors are preferably combined in one measuring unit, in particular in an inertial measuring unit.

This inertial measurement unit measures acceleration and angular velocity on the gearbox block.

For example, if the worm gear 1a rotates with a broken tooth, this would lead to an extraordinary acceleration or extraordinary angular velocity, i.e., a vibration at the gearbox block.

This vibration is particularly evident in the high-frequency components of the measurement signal from the inertial measurement unit or the acceleration or vibration sensor or inertial sensor 36.

If these measurement signals exceed a threshold value, this is interpreted as an indicator of a tooth breakage.

A door movement is understood to mean a complete movement of the darkening, adjusting, or closure device 17 from the open to the closed position or vice versa.

Eight digital signal processing methods, such as FIR filters, can be used in the sensor and evaluation unit to evaluate the measurement signal. A filter with a finite impulse response (FIR filter) is a discrete filter that is usually implemented digitally.

Threshold values can be stored by hard-coding them, for example, or by reference runs during initial operation.

The oil level sensor 39 can be mounted in such a way that the level is detected in both horizontal (see FIGS. 1 and 2) and vertical (see FIG. 3) drive mounting positions.

In turn, the measurement of the external temperature enables a significantly more precise temperature model of the entire drive, since its thermodynamics naturally also depend on the temperature gradient to the environment. This in turn can be used to distinguish between heat generated by the drive itself, e.g., due to excessive power consumption at high load or internal friction or wear, and external temperature influences, e.g., very cold or very warm environments.

In a preferred embodiment of the invention, overheating of the motor is prevented by a temperature model that processes not only the supplied electrical energy but also the ambient temperature.

In addition, the sensor and evaluation unit 8 has a signal display 48 directly on the housing. This means that the user can see the readiness of the drive directly on it, thus immediately ruling out errors on the—often complex—cable route.

Optionally, the invention can be equipped with the motor temperature sensor 37, which prevents the motor 2 from overheating by directly

Furthermore, the invention can also be equipped with a wear sensor 40 that directly measures the material removal at the particularly wear-prone gear components. This sensor can, in particular, measure the material removal at the teeth of the hollow shaft gear wheel, which can be designed, for example, as a worm gear in a copper alloy, such as bronze or brass.

Optionally, the drive unit 20 can be equipped with a brake release sensor 44 that detects when the holding brake 3 is released manually by operating a brake release lever 43, e.g., when the door is opened in an emergency. The signals from this sensor can then trigger the output of warning signals and the activation of other safety functions, for example.

In addition to the sensor data mentioned above, the data provided above may also include events such as detected current or voltage losses in the external or battery power supply, error messages, replacement of the control unit or the data distributor or connection module 9, unusual current, torque or speed peaks or acceleration/shocks or impacts, as well as status messages, such as “initializing”, “ready”, “error”, “emergency stop”, etc., as well as information on the expected remaining service life, calculated on the basis of the indirect or direct wear determination described above.

These events can be evaluated in a memory for the usage history by a part of the self-diagnostic software that is part of the drive, and warnings can be issued to the user if necessary. In special cases, the drive can also be shut down as a preventive measure until maintenance has been carried out.

The state of wear of at least one part of the drive mechanism 20 and/or the darkening, adjusting, or closure device 17 can be output in the present case by means of output means. This information can be output directly at the device 20, in particular by means of a display, optical or acoustic signals, or through interfaces, preferably signal displays 48, to which read-out devices, such as computers, can be connected. It is also conceivable that the wear status of drive components could be displayed wirelessly, for example on smartphones or tablets.

For example, an authorized person can access the sensor and evaluation unit 8 via an interface and configure the corresponding output options.

The entire drive unit 20 and, if applicable, other components, such as the light grid 14, can be controlled, for example, by means of a bus system. Such light grids 14 are shown in FIG. 3.

For example, LEDs on the light grid 14 and/or on the sensor can indicate error states detected by the sensor and evaluation unit 8 when objects or persons are detected.

The display of the door control unit can be mirrored on an external operating unit 15, which is also shown in FIG. 3. The external operating unit 15 is a sub-unit of the drive unit 20. It can be connected directly to the drive unit 20, in particular to the connection module 9, by means of a cable. So that the number of cables is reduced by the central cabling.

It is also conceivable that devices such as a signal light or a display to show the status of the darkening, adjusting, or closure device 17, for example a door status, are connected.

The status of the light grid 14 can also be displayed using this signal display, for example “one beam defective” or “light grid active” or similar.

Conversely, the drive unit 20 can receive continuous and discontinuous data from the control and regulating device 13.

In this configuration, the drive unit 20 is able to diagnose and evaluate its own state with regard to its safety relevance and then to inform the user about it.

This knowledge of the drive unit 20 regarding its own condition is in turn the prerequisite for predictive maintenance in order to prevent brake failure or gearbox breakage, or the breakage of other elements in the power train.

The essential difference to the prior art is the prevention of failure, and not, as in the prior art, for example by means of mechanical tooth breakage protection, the counteraction to a failure that has already occurred, such as a broken tooth.

In addition, due to the mechanical triggering principles of known tooth breakage protection devices, these have a significantly longer reaction time than the electronic fall protection device of the invention.

The state of wear can, for example, be determined indirectly by calculating the oil viscosity and torque per load cycle using a weighted wear model of the invention. This requires the measurement of the lubricating medium temperature (e.g., oil temperature) in the drive, as well as the current consumption per load cycle, since these variables are directly physically related to the sought-after variables of oil viscosity and torque. The downstream evaluation electronics process this sensor data and convert it into the desired variables, for example.

Alternatively, the current consumption can also be measured in the control system of the darkening, adjusting, or closure device 17, as can the calculation of the desired physical quantities of torque, oil viscosity, and speed. The number of cycles could be recorded in the control and/or regulating unit 13 (e.g., the door control unit), for example by means of a cycle counter. The wear-related data determined in this way is stored permanently and independently of the control system in the sensor and evaluation unit.

In this wear model, the counted cycles per cycle can then be weighted with factors based on knowledge of the torque and other influencing variables, e.g., the oil viscosity. These factors can be determined in real wear tests and used in the equations of the wear model.

In addition, the data from the acceleration or vibration sensor 36 or the inertial measurement unit may be used to detect acceleration peaks, particularly those that occur cyclically or in orders of speed, such as those that can occur when the gear components or other components in the power train are damaged.

However, the wear condition of the gearbox 1 can also be detected directly by the wear sensor 40, which continuously measures the width of the teeth of selected gear components during operation.

With the sum of these data, the drive unit 20 can continuously evaluate its own state with regard to its safety relevance and, in conjunction with the control of the darkening, adjusting, or closure device 17, indicate this to the user or, if necessary, initiate measures.

For reasons of electromagnetic compatibility (EMC), as well as the arrangement requirements of the position detection sensors, it is particularly advantageous to place the housing of the sensor and evaluation unit 8 at the position shown in FIGS. 1 and 2. In this context, the thermal decoupling of the sensors from the usually metallic gearbox housing is particularly important, since the aging of electronic components increases exponentially with their ambient temperature. In the invention, this is achieved by the housing being in contact with the gearbox housing at only a few points.

The sensor and evaluation unit 8 has at least one, preferably interchangeable, connection module 9 with connection ports 26 for the connection of signal and data lines 10, 12, wherein the connection module 9 can be connected to the housing section 8a in a particularly releasable manner.

As FIG. 1 also shows, the connection module 9, also known as the data distributor, is designed in this case as a locking and sealing element for the housing section 8a or base housing.

The data distributor or the connection module 9 of the drive unit 20 provides the communication interface to the other system components of the unit 20. Using a gate system as an example, these include light grids, external operating units, radar motion detection systems and signal displays. These components are currently connected to external data distribution boxes, which leads to unnecessary assembly and cabling work and to an increase in complexity and thus also in the probability of errors.

The connection module 9 can also be designed to be cascadable and can offer a configurable number of connections for these components and can therefore also be exchanged later, as required, for one with more connections.

In the present case, the connection module 9 is directly integrated into the drive unit 20 and is directly plugged into a connection board of the sensor and evaluation unit 8 of the drive unit 20, similar to an expansion card of a PC.

The application components or signal displays, such as the light grid 14, the operating unit 15 and the motion detector 16, are connected to the connection module 9 or data distributor via data lines 12. The control and regulating device 13 of the darkening, adjusting, or closure device 17 is also connected directly to the sensor and evaluation unit 8 with the signal line 10 and with the power line 11 at the motor connection box or the connection device 5. The connection module 9 solves the problem of unnecessary cabling from the drive to the module 9 and uses the drive already attached to the gate as a connection point.

This also eliminates the need for installation work and additional interfaces for an external data distributor. In addition, the connection module 9 fulfills the function of a cover for the sensor and evaluation unit 8 and its sealing function. The lid surface forms a continuous, offset-free sealing surface to fulfill even the most stringent sealing requirements. The mating surface of connection module 9 is the base housing 8a of the sensor and evaluation unit 8. The connection module 9 itself, in turn, forms the mating sealing surface on its surface for a connection and maintenance access, for example a maintenance access cover to the sensor and evaluation unit 8.

FIG. 4 shows a further embodiment of the invention. Accordingly, the first brake 3 is arranged by means of a holding and cooling device 7 on the drive motor 2. As can be seen further, the holding and cooling device 7 has at least one laterally arranged air intake 24 for drawing in ambient air to cool the drive motor 2, and a contact surface 25 for the first brake 3 to lie against the drive motor 2, in particular flat, or for flat mounting of the first brake 3 on the drive motor 2.

The state of the art for actively ventilated motors by means of motor shaft rotation provides for a cooling air intake over the surface perpendicular to the motor axis, which is covered by the first brake 3 in the exemplary embodiment shown in FIG. 1. The first brake 3 also places special demands on the planarity of the counter surface on the drive motor 2, as well as special demands on the orthogonality of this surface in relation to the motor shaft to be braked. For this reason, as well as for fluidic reasons, an externally accessible installation of the first brake 3 is not possible when using an actively ventilated drive motor 2 on the motor side (in the motor industry this is called the “B-side”, not to be confused with the following directional definitions) is currently not possible, because it would cover the air intake openings, and thus the arrangement of the brake 3 in these cases is only realizable on the gearbox side—in FIG. 1 the position of component 8b. This restriction is avoided by the invention.

In addition, the installation space is subject to strict restrictions, particularly on the gearbox side. In the case of a gate application, the extension of the drive in direction (A) is adjacent to the ceiling or wall (depending on whether the drive is mounted horizontally or vertically).

At the same time, the installation space is restricted in the direction of (B), (C), and (-C). The installation space in the direction (-B) is also usually predetermined by the application. The installation space available in the direction (-A) with vertical mounting is relatively uncritical, which accounts for the majority of installation directions in the gate industry, for example.

Reference numerals

| | |
|---|---|
| 1 | Gearbox, worm gearbox, transmission |
| 1a | Drive gear, worm gear |
| 1b | Output shaft, hollow shaft |
| 2 | Drive or electric motor, second holding brake |
| 3 | First brake |
| 4 | Emergency actuation device |
| 5 | Connection device (housing and cable) |
| 5a | Cover |
| 6 | Elastically decoupled fastening foot |
| 7 | Holding and cooling device |
| 8 | Sensor and evaluation unit |
| 8a | Base housing |
| 8b | Connection and maintenance access, cover |
| 9 | Connection module (data distributor) |
| 10 | Signal line |
| 10a | Cable cores |
| 11 | Power line |
| 11a | Cable cores |
| 12 | Data line |
| 13 | Control and/or regulating device |
| 14 | Light grid |
| 15 | Operating unit |
| 16 | Motion sensors |
| 17 | Darkening, adjusting, or closure device |
| 18 | Drive shaft, darkening, adjusting, or |
| | closure device |
| 19 | Crank, hand crank |
| 20 | Drive unit |
| 23 | Bearing point drive shaft, darkening, |
| | closure device |
| 24 | Intake air inlets |
| 25 | Contact surface |
| 26 | Connection port |
| 33 | Fan guard |
| 34 | Position Sensing Sensor |
| 35 | External temperature sensor |
| 36 | Vibration sensor (acceleration sensor) |
| 37 | Motor temperature sensor |
| 38 | Emergency actuation switch |
| 39 | Oil level sensor |
| 40 | Wear sensor |
| 41 | Sensor cabling |
| 42 | Wiring for first brake |
| 43 | Brake release lever |
| 44 | Brake-release sensor |
| 45 | Electronic type plate |
| 46 | Storage for usage history |
| 47 | Communication unit |
| 48 | Signal display |
| 49 | Cover and lifting aid |
| A, B, C | direction |
| −A, −B, −C | direction |

1. A drive device (20) for moving a darkening, adjusting, or closure device (18), comprising:
a drive motor (2) to move the darkening, adjusting, or closure device (18), the drive motor (2) having a motor control connected to a control and/or regulating device (10) responsive to an electrical drive signal for controlling the darkening, adjusting, or closure device (18), and having an output shaft;
a gearbox (1) arranged in a drive train between the output shaft of the drive motor (2) and a drive shaft (21) of the darkening, adjusting, or closure device (18); and;
a sensor and evaluation unit (8) firmly connected to the drive device (20) for determining a state of wear of the drive device (20) and/or the drive motor (2) and/or gearing and/or a first brake (3) and/or the darkening, adjusting, or closure device (18), wherein key data of the drive device (20) motor data and/or drive parameters and/or serial numbers and/or manufacturer's designation and/or CE marking and/or utilization history and/or alternative conformity information and/or other data pertinent to operation of the drive device (2) are stored in the sensor and evaluation unit (8) in the form of an electronic type plate (45), and wherein the sensor and evaluation unit (8) is connected to the control and/or regulating device (10) for the purpose of transmitting and receiving data.

2. The drive device (20) according to claim 1, further comprising: a first brake (3) operatively connected to the drive motor (2), wherein in order to brake and hold the darkening, adjusting, or closure device (18) in a predetermined position, the first brake (3) builds up a holding torque on the darkening, adjusting, or closure device (18), and wherein the sensor and evaluation unit (8) is adapted to detect state of wear of the darkening, adjusting, or closure device (18) and/or wherein the first brake (3) is activated as a function of the data determined by the sensor and evaluation unit (8).

3. The drive device (20) according to claim 1, wherein the sensor and evaluation unit (8) has
an endlessly revolving position signal generator with a position-detecting sensor (34) for detecting position and/or rotational speed and/or direction of rotation of the darkening, adjusting, or closure device (18) and/or
a wear sensor (40) for a direct wear measurement of a gear wheel of the gearbox (1) and/or
an acceleration or vibration sensor or inertial sensor (36) and/or
an inertial measurement unit and/or
a motor temperature sensor (37) and/or
an oil level sensor (39) and/or
a sensor for detecting brake release and/or
a sensor for detecting emergency braking actuation.

4. The drive device (20) according to claim 3, wherein the sensor and evaluation unit (8) has the inertial measurement unit, and wherein the inertial measurement unit has at least one acceleration or vibration sensor (36) and/or at least one rotation rate sensor.

5. The drive device (20) according to claim 3, wherein the sensor and evaluation unit (8) has the position detection sensor (34), and wherein the position detection sensor (34) detects a number of rotations and/or angles of rotation with a magnetic field sensor and a permanent magnet arranged on the shaft of a gearing component.

6. The drive device (20) according to claim 1, wherein the sensor and evaluation unit (8) has an indirect wear detection means having at least one cycle counter that may be a weighted cycle counter, which determines at least one input variable of torque and/or number of revolutions per cycle and uses the at least one input variable in a weighting model.

7. The drive device (20) according to claim 1, wherein state of wear of at least one part of the drive mechanism (20) and/or of the darkening, adjusting, or closure device (18) can be output from the drive device (20).

8. The drive device (20) according to claim 1, further comprising at least a second brake for braking and holding the darkening, adjusting, or closure device (18), wherein a holding torque is applied to the drive motor (2) via the second brake in the case of failure of the first brake (3) via the drive motor (2), and wherein by building up a holding torque of the drive motor (2) in the opposite direction of movement, a holding torque is built up on the darkening, adjusting, or closure device (18).

9. The drive device (20) according to claim 8, wherein the second brake is an electronic fall protection device (17), and wherein the electronic fall protection device can be activated by means of a signal detected by the sensor and evaluation unit (8), so that if the sensor and evaluation unit (8) detects a failure of the first brake (3), the sensor and evaluation unit (8) transmits a signal to the electronic fall protection device (17) to build up a torque of the drive motor (2) connected to the electronic fall protection device (17), which torque opposes an unauthorized direction of movement.

10. The drive device (20) according to claim 1, wherein the sensor and evaluation unit (8) is arranged on a housing section (8a) of the device (20) or of the gearbox (1), and/or forms a housing section (8a) of the device (20) or of the gearbox (1), and wherein the housing section (8a) has an opening which can be closed by a housing section lid and/or by a connection and maintenance access (8b).

11. The drive device (20) according to claim 1, wherein the sensor and evaluation unit (8) has at least one connection module (9) with at least one connection port (26) for connecting signal and data lines (14, 15), and wherein the connection module (9) is adapted to be releasably connected to the housing section (8a).

12. The drive device (20) according to claim 11, wherein the sensor and evaluation unit (8) is arranged on a housing section (8a) of the device (20) or of the gearbox (1), and/or forms a housing section (8a) of the device (20) or of the gearbox (1), and wherein the connection module (9) is configured as a closure and sealing element for the housing section (8a) and has a connection and maintenance opening (8b) adapted to be closed by a lid.

13. The drive device (20) according to claim 1, further comprising: an emergency actuation device (4) for manual actuation of the output shaft of the drive motor (2) in the event of failure of the drive motor (2).

14. The drive unit (20) according to claim 13, wherein the emergency actuation device (4) comprises a hand crank (19) mounted in a corresponding receptacle of the emergency actuation device (4), and further comprising an emergency actuation switch (38) for detecting [a] the hand crank (19).

15. The drive device (20) according to claim 1, further comprising: a connection device (5) for electrical energy, wherein the connection device (5) has a plug-and-socket connection for the connection of the electrical energy, wherein at least one connection cable has a part of the plug connection that is adapted to be plugged into a corresponding counterplug on the drive device (20).

16. The drive device (20) according to claim 1, further comprising: a holding and cooling device (7) by which the first brake (3) is arranged on or mounted to the drive motor (2), wherein the holding and cooling device (7) has at least one laterally arranged intake air inlet (24) for drawing in ambient air for cooling the drive motor (2) and a contact surface (25) for the first brake (3) to rest against the drive motor (2), or for flat mounting of the first brake (3) on the drive motor (2).

17. The drive device (20) according to claim 1, further comprising: a proximity sensor (44); operatively connected to the sensor and evaluation unit (8) [,] for detecting mechanical movement of a brake release lever.

18. The drive device (20) according to claim 1, further comprising: at least one signal display (48) for signaling an operating state of the drive device (20) and/or for signaling a state of wear of at least one part of the drive device (20) and/or for signaling a state of wear of the darkening, adjusting, or closure device (17).

19. The drive device (20) according to claim 1, further comprising: a position sensor (34) having a shaft arranged substantially perpendicular to the motor output shaft axis in the gearbox (1), and wherein the position sensor shaft is adapted to be driven by the gearbox drive shaft.
